(19) United States
(12) Patent Application Publication
(10) Pub. No.: US 2017/0286311 A1
(43) Pub. Date: Oct. 5, 2017

(54) REPETITIVE ADDRESS INDIRECTION IN A MEMORY

(71) Applicants: Dale J. JUENEMANN, North Plains, OR (US); Anand S. RAMALINGAM, Beaverton, OR (US)

(72) Inventors: Dale J. JUENEMANN, North Plains, OR (US); Anand S. RAMALINGAM, Beaverton, OR (US)

(21) Appl. No.: 15/089,368

(22) Filed: Apr. 1, 2016

(51) Int. Cl. G06F 12/10

(52) U.S. Cl. CPC G06F 12/10; G06F 2212/1041; G06F 2212/202; G06F 2212/657

(57) ABSTRACT

In one embodiment, repetitive address indirection is employed to repetitively redirect write operations to different physical locations of the memory. In one embodiment, write data for every write operation is automatically, unconditionally and repetitively redirected to physical addresses in a memory in a circular sequence of physical addresses of the memory independently of, that is without regard to, the logical address of each write operation. As a result, successive write operations to the memory are automatically evenly distributed over the memory, even if repeatedly directed to the same or similar logical address. Other aspects are described herein.

### TECHNICAL FIELD

Certain embodiments of the present description relate generally to management of input and output operations for a memory.

### BACKGROUND

In contrast to volatile memory, non-volatile memory can store data that persists even after the power is removed from thenon-volatile memory. However, due to certain characteristics of non-volatile memory, additional memory management logic and other circuitry has been provided for the non-volatile memory that may not be needed for other types of memory.

### BRIEF DESCRIPTION OF THE DRAWINGS

Embodiments of the present disclosure are illustrated by way of example, and not by way of limitation, in the figures of the accompanying drawings in which like reference numerals refer to similar elements.

FIG. 1 depicts a high-level block diagram illustrating one embodiment of a system employing repetitive address redirection in accordance with the present description.

FIG. 2 depicts a basic architecture of a memory employing repetitive address indirection in accordance with the present description.

FIGS. 3a-3b depict a schematic diagram of an embodiment of a memory employing repetitive address indirection in accordance with the present description.

FIGS. 4a-4c depict embodiments of operations of the memory of FIG. 2.

FIGS. 5a, 5b depict examples of a data structure mapping logical addresses to physical addresses for the memory of FIG. 2.

FIGS. 6a, 6b depict another example of a memory employing repetitive address indirection in accordance with the present description.

FIG. 7 shows an example of a prior art storage format for storing metadata, user data payload and error detection and correction data.

FIG. 8 shows an example of a storage format for storing metadata, user data payload and error detection and correction data for the memory of FIG. 2.

### DESCRIPTION OF EMBODIMENTS

Non-volatile memory bitcells may wear out after a certain number of access operations such as write operations. Accordingly, non-volatile memory such as write-in-place Non-volatile Random Access Memory (NVRAM), frequently incorporates wear leveling logic which employs algorithms to occasionally redirect selected write operations from one physical location to another to more evenly distribute those write operations across bitcells. As a result, write operations determined to be directed too frequently to the same physical location may be redirected to a different physical location to prevent or defer wearing out the bitcells at any one particular physical address.

Thus, the wear leveling logic may include access cycle count logic to keep track of the number of access cycles experienced by each memory location and store the access cycle count in metadata maintained for each memory location, in that location. If the number of access cycles for a particular memory location (often referred to as a “hot” location) exceeds a certain redistribution threshold value programmed into the memory management logic, memory location redistribution logic can redistribute the memory accesses for that memory location to other locations having a lesser degree of access (often referred to as a “cold” location to provide a more even distribution of the memory accesses over the various locations within the memory. In this manner, the wear leveling logic swaps a hot location with a cold location.

The wear leveling logic may further include memory location mapping rotation logic to periodically rotate the mapping of logical block addresses (LBA) to physical block addresses (PBA) for the entire memory, for purposes of write operation redistribution. For example, if a particular LBA is being continually written with repeated accesses, a swapped to cold PBA eventually becomes a hot PBA, causing another hot to cold PBA swap. This will cause the original hot PBA to become hotter as the metadata is updated. Continued accesses and metadata updates due to hot to cold swaps may eventually destroy a memory location. As a result, rotation logic may be employed to periodically rotate the mapping of all logical block addresses of the entire NVRAM memory to different physical addresses. Such a rotation may take place after expiration of a particular period of time. In this manner, the relationship between LBA and PBA may be dynamically changed over days of operation to attempt to preserve physical locations from damage.

Excessive memory accesses to a particular NVRAM location can adversely affect not only that location being accessed but also neighboring locations. One such adverse effect is frequently referred to as the “write victim” (or write disturb) effect in which data stored in neighboring memory locations can be inadvertently lost due to excessive write operations to an adjacent memory location. To avoid write victim loss of data in neighboring memory locations, memory management logic may utilize data preservation logic such as write victim refresh logic which compares a write victim refresh threshold value to a write access cycle count being stored in metadata. If the write access cycle count exceeds this write victim refresh threshold value, an interrupt is generated. In response to the interrupt, the write victim refresh logic refreshes the content of neighboring potential write victim memory locations to preserve the data stored in the neighboring locations.

Another such adverse effect is frequently referred to as the “read disturb” effect in which bit states stored in neighboring memory locations can be inadvertently programmed if the number of read operations as represented by a read access cycle count exceeds a read disturb threshold number of read operations before the memory block is erased. One prior technique for avoiding or reducing the read disturb effect is for data preservation logic of the memory management logic to keep track of the total number of reads to a block of memory since the last erase operation to the block. When the count exceeds a read disturb target limit, the affected block is relocated, that is, copied over to a new block. Another prior technique selects blocks of memory for relocation using statistical algorithms to select blocks for relocation before the data of a block is affected by the read disturb effect.

In the description that follows, like components have been given the same reference numerals, regardless of whether they are shown in different embodiments. To illustrate one or more embodiments of the present disclosure in a clear and concise manner, the drawings may not necessarily be to scale and certain features may be shown in somewhat schematic form. Features that are described or illustrated with respect to one embodiment may be used in the same way or in a similar way in one or more other embodiments or in combination with or instead of features of other embodiments.

It is appreciated herein that wear leveling logic employed by prior memory management logic to avoid damage caused by an excessive number of access operations to particular memory locations, may consume substantial resources, adversely affecting performance and increasing cost. Similarly, data preservation logic provided to detect and avoid data loss or corruption due to an excessive number of access operations to particular memory locations, can also consume valuable resources and adversely affect performance.

In one aspect of the present description, repetitive address indirection is employed to repetitively redirect write operations to different physical locations of the memory. In one embodiment, write data for every write operation is automatically, unconditionally and repetitively redirected to physical addresses in a memory in a circular sequence of physical addresses of the memory independently of, that is without regard to, the logical address of each write operation. As a result, successive write operations to the memory are automatically evenly distributed over the memory, even if repeatedly directed to the same or similar logical address. Because the write operations are automatically evenly distributed in an automatic unconditional repetitive sequential fashion without regard to the number of accesses directed to any one location, memory management may be significantly simplified. Such simplification may be achieved not only by a reduction in logic circuitry and programming previously employed for complex conditional, nonsequential access redirection and refresh operations, but also in a reduction in metadata and associated error correction codes previously stored in each memory location for bitcell and data preservation purposes.

For example, an excessive number of memory write access cycles to the same memory location, can adversely affect not only the location being accessed but also neighboring locations. In certain types of NVRAM, the bitcells may wear out after a certain number of access operations such as write operations. Accordingly, prior memory management in an NVRAM frequently incorporates complex wear leveling logic to redistribute write operations to avoid an excessive number of write operations to any one location. The prior wear leveling logic may include write access cycle count logic to keep track of the number of write access cycles experienced by each memory location. If the number of write access cycles for a particular memory location exceeds a certain redistribution threshold value programmed into the memory management logic, a condition is met and memory location redistribution logic previously redirected, that is, relocated the write data to a different physical memory location having a lower number of write access cycles. Relatively complex algorithms are frequently employed by the prior memory location redistribution logic to select an appropriate relocation destination having a lower number of write access cycles so as to achieve a more even distribution of write operations over the memory. For example, random address generators may be employed to select random addresses to relocate data in a memory location which may be being excessively accessed. A mapping table which maps logical addresses to physical addresses is updated to indicate the new physical location associated with that logical address.

In contrast, in a memory employing repetitive address indirection in accordance with one aspect of the present description, write data is automatically written to physical addresses in a memory in a circular sequence of physical addresses of the memory independently of the logical address of each write operation and in some embodiments, without keeping track of excessive memory operations. Because the write operations are automatically evenly distributed, wear leveling logic may be reduced or eliminated. For example, write access cycle count logic which previously tracked the number of memory write access cycles for each memory location, may be reduced or eliminated. In addition, memory location redistribution logic which selected the relocation destinations using various algorithms to more evenly distribute the write operations when the threshold was exceed, may also be reduced or eliminated.

In one embodiment for a memory employing repetitive address indirection in accordance with the present description, for every received write operation, a next-in-sequence physical address of a circular sequence of physical addresses of the memory is selected. For example, a head address pointer may be incremented to automatically and unconditionally point to the next-in-sequence physical address of the circular sequence of physical addresses. The write operation is performed at the selected next-in-sequence physical address and the logical address of the memory operation is mapped to the selected physical address. If the automatic incrementally selected physical address is the ending address of the circular sequence of physical addresses, the circular sequence of physical addresses is restarted so that the next-in-sequence physical address to be selected is the beginning physical address of the circular sequence of physical addresses.

As a result, write operations to the memory are automatically evenly distributed over the memory, even if directed to the same or similar logical address. In addition to facilitating substantial simplification of memory management logic by reducing or eliminating write access cycle count logic tracking a write access cycle count for each memory location, the metadata stored at each memory location may be simplified and reduced in size by eliminating write leveling metadata storing a write access cycle count for each memory location. As a result, the amount of memory available for storing user data may be increased without increasing the size of the memory. In addition, by eliminating write leveling metadata, logic for accessing particular wear leveling metadata fields may be reduced or eliminated.

Another characteristic of some types of NVRAM is that read or write operations to one area of the NVRAM may be influenced by the states of neighboring or adjacent areas of the NVRAM. Accordingly, NVRAM frequently employs isolation circuitry and other techniques to isolate the neighboring memory regions from a particular area or region being accessed to prevent such inadvertent effects. For example, an inhibit voltage may be employed to isolate neighboring areas from influencing the area selected for access. However, if multiple operations are directed to the same area of the NVRAM, the resultant isolation employed during such access operations may adversely affect the state or states of the neighboring memory areas, often referred to as “write victims.” As a result, refresh operations provided by suitable tracking circuitry have been applied to the neighboring or “write victim” areas to counteract the effects of the isolation.

For example, in some existing NVRAM, write victim refresh logic of the memory management logic stores a write victim refresh threshold value which is compared to the write access cycle count for a memory location being accessed. When the write cycle count exceeds this write victim refresh threshold value, an interrupt is generated. In response to the interrupt, the write victim refresh logic refreshes the content of neighboring “write victim” memory locations. In addition, the write victim refresh logic bumps the write victim refresh threshold value for that memory location to a higher value. When the write cycle access count for this memory location exceeds this higher write victim refresh threshold value, an interrupt is again generated, causing the refresh of the neighboring “write victim” memory location again and the resetting of the write victim refresh threshold value to a higher still value.

In contrast, in a memory employing repetitive address indirection in accordance with one aspect of the present description, write data is automatically written to physical addresses in a memory in a circular sequence of physical addresses to automatically evenly distribute write operations over the memory. As a result, a potential victim location is automatically updated before needing a refresh. Consequently, any need to track write victims, and the associated write victim refresh logic of prior memory management logic may be reduced or eliminated. In addition, write victim refresh metadata storing the write access cycle count and write victim refresh threshold value for each memory location may be reduced or eliminated as well. As a result, the amount of memory available for storing user data may be increased without increasing the size of the memory. Still further, by eliminating write victim refresh metadata, logic for accessing particular write victim refresh metadata fields may be reduced or eliminated.

An NVRAM typically has a maximum write access cycle threshold which if exceeded for a particular memory location, can cause that particular memory location to fail. In a denial of service attack, the attacker may direct a large number of write operations to a single memory location. In an NVRAM employing prior memory management logic, the number of write operations in a denial of service attack may be so large that the maximum write access cycle threshold may be exceeded for a particular memory location notwithstanding the redistribution by the wear leveling logic of the NVRAM due to overheads from metadata writing. As a result, portions of the NVRAM employing prior memory management logic may be damaged by the denial of service attack.

To avoid such damage, the wear leveling logic of some prior memory management logic may employ memory location mapping rotation logic to periodically rotate the mapping of logical block addresses (LBA) to physical block addresses (PBA) for the entire memory, for purposes of write operation redistribution. The memory location mapping rotation logic may utilize a uniform mapping offset value between logical block addresses (LBA) and physical block addresses (PBA). The uniform mapping offset value is periodically changed to rotate the mapping between logical block addresses (LBA) and physical block addresses (PBA) for the entire memory. For example, the uniform mapping offset value may be initially set to zero such that the beginning LBA address, LBA0 is mapped to PBA0. In a similar manner the ending LBA address, LBA “end”, is mapped to PBA “end.” The intermediate LBA's are mapped to PBA's in a similar fashion.

After some threshold amount of time, the uniform mapping offset value is incremented to a value of one, such that the beginning LBA address, LBA0 is mapped to PBA1 instead of the beginning PBA0. In a similar manner the ending LBA address, LBA “end”, is mapped to the beginning PBA0, instead of the ending PBA “end”. The intermediate LBA's are mapped to PBA's in a similar fashion, utilizing the uniform mapping offset value, to rotate the mapping between the LBA's and the PBA's of the entire memory.

The mapping of LBAs to PBAs is cyclically rotated in this fashion for the entire memory, each cycle of rotation being initiated upon expiration of a period of time equal to the threshold amount of time. It is appreciated that memory location mapping rotation logic can be relatively complex and can consume substantial system resources in rotating the LBA to PBA mapping for the entire memory each cycle. In contrast, in a memory employing repetitive address indirection in accordance with one aspect of the present description, write data for every write operation is automatically and repetitively redirected to physical addresses in a memory in a circular sequence of physical addresses to automatically evenly distribute write operations over the memory. Thus, each page of memory automatically has an equal or substantially equal number of memory operation write access cycles. As a result, the likelihood of any one memory location exceeding the maximum write access cycle threshold, is reduced or eliminated. Further, memory location mapping rotation logic of prior memory management logic may be reduced or eliminated. In addition, the consumption of resources by such prior memory location mapping rotation logic, may be reduced or eliminated as well.

In some non-volatile memory, read operations directed to a particular location can adversely affect nearby bitcells. This phenomenon, often referred to as “read disturb” can cause nearby bitcells in the same block of memory to become inadvertently programmed if the number of read operations exceeds a “read disturb” threshold number of read operations before the memory location is written to. The “read disturb” threshold number of read operations before a write operation, which can cause a read disturb to nearby bitcells, is frequently in the hundreds of thousands of read operations between intervening write operations. Although the read disturb does not affect the bitcell being read, if the number of read operations to that location exceeds the read disturb threshold, the nearby bitcells may be inadvertently programmed as noted above.

One prior technique for avoiding or reducing the read disturb problem is for the memory management logic to count, that is, keep track of the total number of reads to the memory location since the last write operation to the location. After a write operation, the read count is reset. However, if the count exceeds a “read disturb” target limit, the affected location is relocated, that is, copied over to a new location. Another prior technique selects memory addresses for relocation using statistical algorithms.

Accordingly, previous memory location redistribution logic redirected, that is, relocated data to a different physical memory location having a lower number of read access cycles. Relatively complex algorithms are frequently employed by the memory location redistribution logic to select an appropriate relocation destination having a lower number of read or write access cycles so as to avoid the read disturb phenomenon. A mapping table which maps logical addresses to physical addresses is updated to indicate the new physical location of that logical address.

In contrast, in a memory employing repetitive address indirection in accordance with one aspect of the present description, the new memory locations of data being relocated to avoid a read disturb are automatically selected in a circular sequence of physical addresses of the memory independently of the logical address of each write operation. As a result, prior memory location redistribution logic which calculated or otherwise selected relocation destinations in a relatively complex fashion to more evenly distribute the read operations when the “read disturb” target limit, was exceeded, may also be reduced or eliminated.

In one embodiment of repetitive address redirection in accordance with the present description, for each data relocation operation, a next-in-sequence physical address of a circular sequence of physical addresses of the memory is selected in a manner similar to that described in connection with a received write operation. For example, a head address pointer may be incremented to point to the next-in-sequence physical address of the circular sequence of physical addresses. The write operation of the relocation operation is performed at the selected next-in-sequence physical address and the logical address of the relocated data is mapped to the selected physical address. If the selected physical address is the ending address of the circular sequence of physical addresses, the circular sequence of physical addresses is restarted so that the next-in-sequence physical address to be selected is the beginning physical address of the circular sequence of physical addresses.

In another aspect of the present description, in connection with incrementing a head address pointer to point to the next-in-sequence circular memory physical address of the circular sequence of physical addresses, a tail address pointer may be incremented to point to an offset next-in-sequence physical address of the circular sequence of physical addresses. In one embodiment, the offset next-in-sequence physical address pointed to by the tail address pointer is offset from the next-in-sequence physical address pointed to by the head address pointer by a predetermined number of physical addresses. As explained in greater detail below, the offset defined by a number of physical addresses between the head address pointer and the tail address pointer defines a spare memory having a capacity which includes the predetermined number of physical addresses. Write operations may be directed to sequential locations within the spare memory portion.

It is appreciated that repetitive address indirection in accordance with the present description may be applied to a variety of NVRAM and other memory devices such as for example, memory devices that use chalcogenide phase change material (e.g., chalcogenide glass), three-dimensional (3D) crosspoint memory, or memory that incorporates memristor technology. Additional memory devices which may benefit from repetitive address indirection in accordance with the present description may include other types of byte-addressable, write-in-place non-volatile memory, ferroelectric transistor random-access memory (FeTRAM), nanowire-based non-volatile memory, Magnetoresistive random-access memory (MRAM), Spin Transfer Torque (STT)-MRAM, Phase Change Memory (PCM), storage class memory (SCM), universal memory, Ge2Sb2Te5, programmable metallization cell (PMC), resistive memory (RRAM), RESET (amorphous) cell, SET (crystalline) cell, PCME, Ovshinsky memory, ferroelectric memory (also known as polymer memory and poly(N-vinylcarbazole)), ferromagnetic memory (also known as Spintronics, SPRAM (spin-transfer torque RAM)), STRAM (spin tunneling RAM), magnetic memory, magnetic random access memory (MRAM), and Semiconductor-oxide-nitride-oxidesemiconductor (SONOS, also known as dielectric memory). It is appreciated that other types of memory may benefit from repetitive address indirection in accordance with the present description, depending upon the particular application.

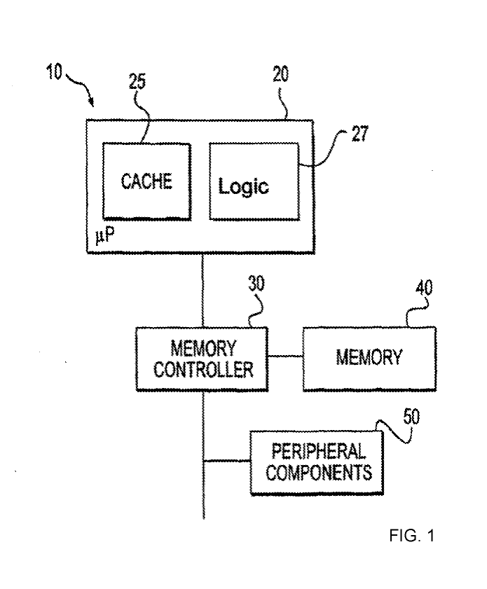

Turning to the figures, FIG. 1 is a high-level block diagram illustrating selected aspects of a computing system implemented, according to an embodiment of the present disclosure. System 10 may represent any of a number of electronic or other computing devices, that may include a memory device. Such electronic devices may include computing devices such as a mainframe, server, personal computer, workstation, telephony device, network appliance, virtualization device, storage controller, portable or mobile devices (e.g., laptops, netbooks, tablet computers, personal digital assistant (PDAs), portable media players, portable gaming devices, digital cameras, mobile phones, smartphones, feature phones, etc.) or component (e.g. system on a chip, processor, bridge, memory controller, memory, etc.). System 10 can be powered by a battery, renewable power source (e.g., solar panel), wireless charging, or by use of an AC outlet.

In alternative embodiments, system 10 may include more elements, fewer elements, and/or different elements. Moreover, although system 10 may be depicted as comprising separate elements, it will be appreciated that such elements may be integrated on to one platform, such as systems on a chip (SoCs). In the illustrative example, system 10 comprises a microprocessor 20, a memory controller 30, a memory 40 and peripheral components 50 which may include, for example, video controller, input device, output device, storage, network adapter, a power source (including a battery, renewable power source (e.g., photovoltaic panel), wireless charging, or coupling to an AC outlet), etc. The microprocessor 20 includes a cache 25 that may be part of a memory hierarchy to store instructions and data, and the system memory 40 may also be part of the memory hierarchy. Communication between the microprocessor 20 and the memory 40 may be facilitated by the memory controller (or chipset) 30, which may also facilitate in communicating with the peripheral components 50.

Storage of the peripheral components 50 may be, for example, non-volatile storage, such as solid-state drives (SSD), magnetic disk drives, optical disk drives, a tape drive, flash memory, etc. The storage may comprise an internal storage device or an attached or network accessible storage. The microprocessor 20 is configured to write data in and read data from the memory 40. Programs in the storage are loaded into the memory and executed by the processor. A network controller or adapter enables communication with a network, such as an Ethernet, a Fiber Channel Arbitrated Loop, etc. Further, the architecture may, in certain embodiments, include a video controller configured to display information represented by data in a memory on a display monitor, where the video controller may be embodied on a video card or integrated on integrated circuit components mounted on a motherboard or other substrate. An input device is used to provide user input to the processor, and may include a keyboard, mouse, pen-stylus, microphone, touch sensitive display screen, input pins, sockets, or any other activation or input mechanism known in the art. An output device is capable of rendering information transmitted from the processor, or other component, such as a display monitor, printer, storage, output pins, sockets, etc. The network adapter may embodied on a network card, such as a Peripheral Component Interconnect (PCI) card, PCI-express, or some other I/O card, or on integrated circuit components mounted on a motherboard or other substrate.

One or more of the components of the device 10 may be omitted, depending upon the particular application. For example, a network router may lack a video controller, for example.

Any one or more of the memory devices 25, 40, and the other devices 10, 30, 50 may include a memory employing repetitive address indirection in accordance with the present description, or be embodied as any type of data storage capable of storing data in a persistent manner (even if power is interrupted to non-volatile memory) such as but not limited to any combination of memory devices that use for example, chalcogenide phase change material (e.g., chalcogenide glass), three-dimensional (3D) crosspoint memory, or other types of byte-addressable, write-in-place non-volatile memory, ferroelectric transistor random-access memory (FeTRAM), nanowire-based non-volatile memory, phase change memory (PCM), memory that incorporates memristor technology, Magnetoresistive random-access memory (MRAM) or another Spin Transfer Torque (STT)-MRAM as described above. Such memory elements in accordance with embodiments described herein can be used either in stand-alone memory circuits or logic arrays, or can be embedded in microprocessors and/or digital signal processors (DSPs). Additionally, it is noted that although systems and processes are described herein primarily with reference to microprocessor based systems in the illustrative examples, it will be appreciated that in view of the disclosure herein, certain aspects, architectures, and principles of the disclosure are equally applicable to other types of device memory and logic devices.

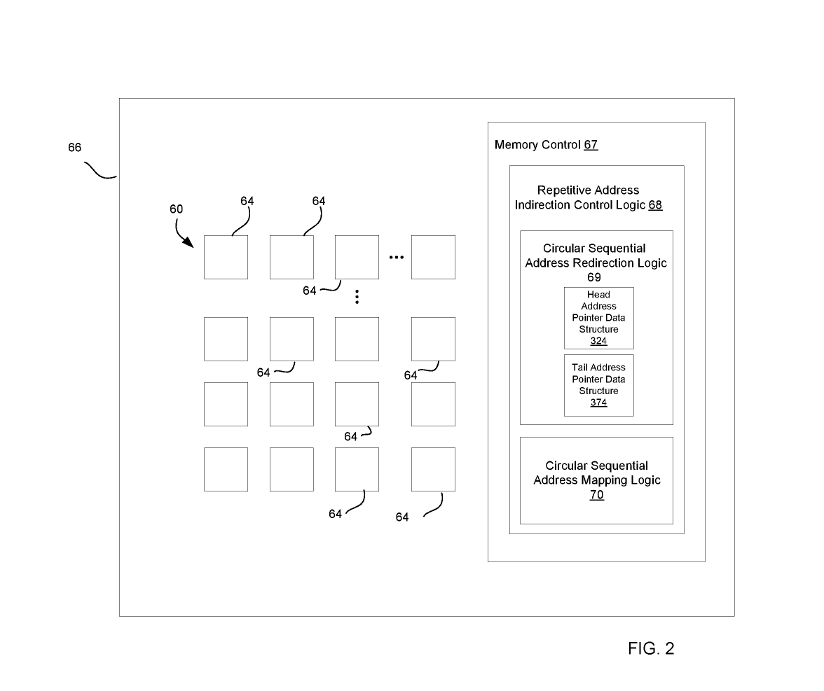

FIG. 2 shows an example of a solid state drive (SSD) having a rectangular or orthogonal array 60 of rows and columns of NVRAM bitcells such as the bitcells 64 of a NVRAM memory 66 employing repetitive address indirection in accordance with one embodiment of the present description. Each bitcell 64 is configured to store a bit state.

The NVRAM memory 66 of the SSD may also include a row decoder, a timer device and I/O devices (or I/O outputs). Bits of the same memory word may be separated from each other for efficient I/O design. A multiplexer (MUX) may be used to connect each column to the required circuitry during a READ operation. Another MUX may be used to connect each column to a write driver during a WRITE operation. A control circuit 67 such as a memory controller is configured to control and perform read and write operations directed to the bitcells 64 as explained below. The control circuit 67 is configured to perform the described operations using appropriate hardware, software or firmware, or various combinations thereof. As explain in greater detail below, the control circuit 67 includes repetitive address indirection control logic 68 which includes circular sequential address redirection logic 69 and circular sequential address mapping logic 70 in accordance with one aspect of the present description.

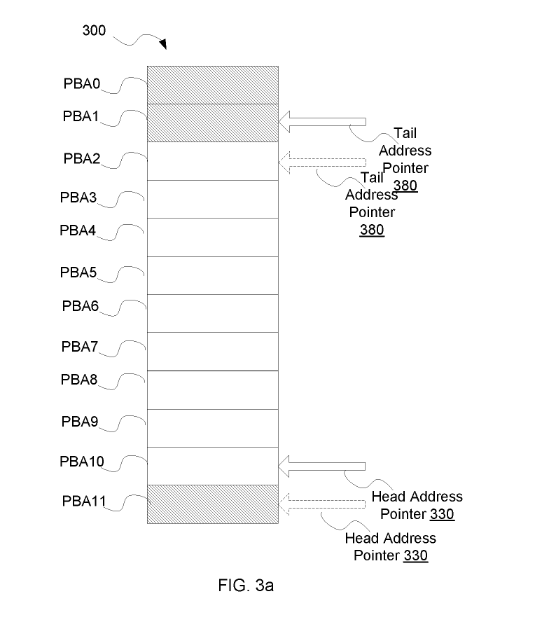

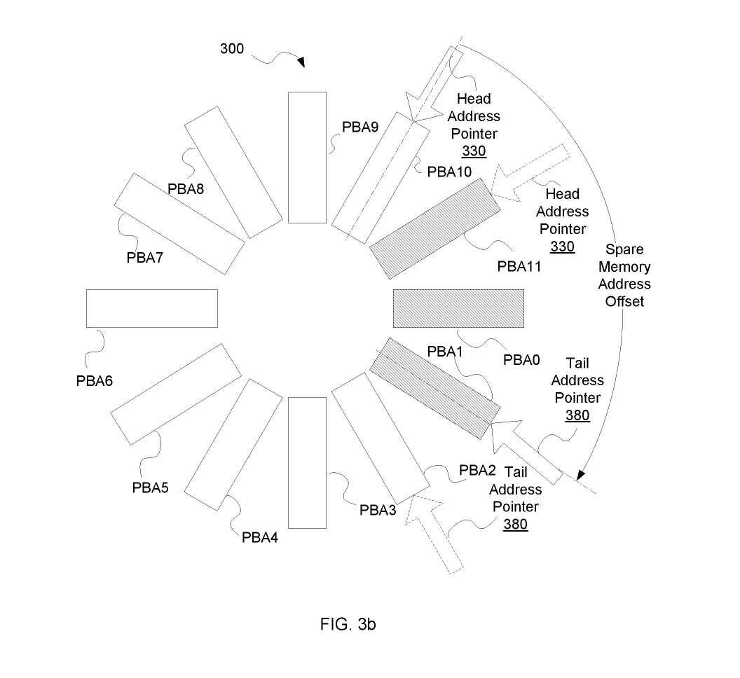

FIGS. 3a, 3b show an example of a block 300 of memory locations of a memory 66 (FIG. 2) employing repetitive address indirection in accordance with one embodiment of the present description. It is anticipated that in many applications, the block 300 may have thousands, millions, billions or more memory locations. However, for purposes of clarity, FIGS. 3a, 3b depict 12 such representative memory locations, each having a physical block address PBA0, PBA1, . . . PBA11 in this example. In one embodiment, each memory location PBA0, PBA1, . . . PBA11, has sufficient bitcells to store tens, hundreds, or a thousand or more bytes of data, depending upon the particular application.

FIG. 3a depicts the block 300 of memory locations as being physically organized in a generally rectangular block of memory locations. However, it is appreciated that other physical organizational shapes may be utilized, depending upon the particular application. In accordance with one aspect of the present description, FIG. 3b depicts a logical organization of the memory locations of the block 300 which includes a circular mapping of the memory locations of the block 300 in a circular sequence of repeating physical block addresses PBA0, PBA1, . . . PBA11 in which the ending physical block address PBA11 in this example, is followed by the beginning physical block address PBA0 of the repeating circular sequence of physical block addresses. Thus, in the example of FIG. 3b, the circular sequence of physical addresses starts at a beginning physical block address PBA0 of the circular sequence, ends at an ending physical address PBA11 of the circular sequence of physical addresses and includes physical block addresses PBA1-PBA10 intermediate the beginning (PBA0) and ending (PBA11) physical addresses of the circular sequence. As explained in greater detail below, the physical addresses of the circular sequence of physical addresses are selected for write operations in sequential order of the circular sequence. Because of the circular logical organization of the physical addresses, once the ending physical address of the circular sequence is reached, the sequence repeats starting at the beginning physical block address of the circular sequence, PBA0. Thus, in the embodiment of FIG. 3b, following the ending physical block address PBA11 of the circular sequence of physical addresses, the circular sequence of physical addresses restarts, that is, begins again, such that the beginning physical block address PBA0 of the circular sequence is selected as a next-in-sequence physical address of the circular sequence of physical addresses.

In one aspect of the present description, write data is written to physical addresses in a memory in the repeating circular sequence of physical block addresses PBA0, PBA1, . . . PBA11 independently of the logical address of each write operation. As a result, write operations to the memory are automatically evenly distributed over the memory, even if directed to the same or similar logical address.

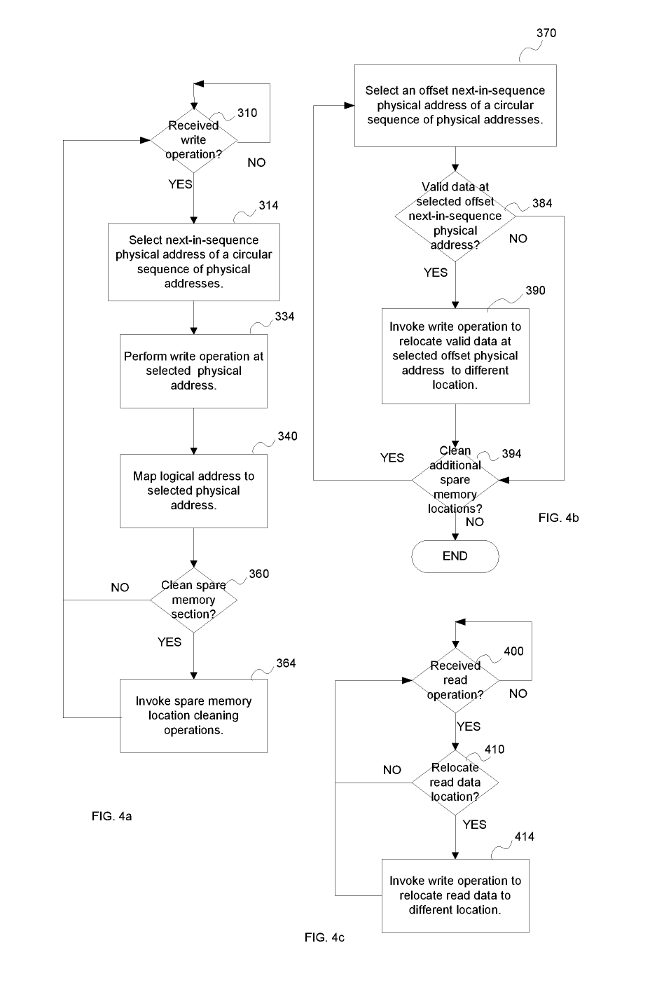

FIG. 4a depicts one example of write operations of a memory employing repetitive address indirection in accordance with one embodiment of the present description. In connection with the receipt (block 310, FIG. 4a) of a write operation from a host, a core, a microprocessor or direct memory access (DMA) controller, for example, a next-in-sequence physical address of the circular sequence of physical addresses of the memory is selected (block 314). In the illustrated embodiment, a repetitive address indirection control logic 68 (FIG. 2) of the memory control 67 is configured to receive (block 310, FIG. 4a) write operations for writing data to logical addresses of a memory such as the memory 66 (FIG. 2) which includes the block 300 (FIG. 3a, 3b) of memory locations PBA0, PBA1, . . . PBA11. The repetitive address indirection control logic 68 (FIG. 2) of the memory control 67 includes circular sequential address redirection logic 69 (FIG. 2) configured to, for each received write operation, select (block 314, FIG. 4a) a next-in-sequence physical address of a circular sequence of physical addresses of the memory. As explained below, the repetitive address indirection control logic 68 is further configured to write data of the write operations to physical addresses in the memory in the circular sequence of physical addresses of the memory. More specifically, the circular sequential address redirection logic 69 of the repetitive address indirection control logic 68, is configured to perform the received write operation at the selected next-in-sequence physical address. In this manner, successive received write operations are repetitively redirected to different physical addresses in a circular sequence of physical addresses to uniformly distribute write operations over the memory.

In the illustrated embodiment, the circular sequential address redirection logic 69 (FIG. 2) has a head address pointer data structure 324 configured to store a head address pointer 330 (FIGS. 3a, 3b) as represented by a head address pointer arrow. The circular sequential address redirection logic 70 (FIG. 2) is configured to write the data of a received write operation at a memory physical address pointed to by the head address pointer 330. In the example of FIGS. 3a, 3b the head address pointer 330 is shown pointing to the memory location having physical block address PBA10 indicating that the last write operation wrote data in the memory location having physical block address PBA10.

In connection with receipt (block 310, FIG. 4a) of a write operation, and selecting (block 314, FIG. 4a) a next-in-sequence physical address of a circular sequence of physical addresses of the memory, the circular sequential address redirection logic 69 of the repetitive address indirection control logic 68, is further configured to automatically and unconditionally increment (block 314, FIG. 4a) the head address pointer 330 to point to the next-in-sequence physical address of the circular sequence of physical addresses. In the example of FIGS. 3a, 3b the head address pointer 330 as represented by the arrow depicted in phantom, is incremented to point to the next-in-sequence physical address of the circular sequence of physical addresses, which in this example is the memory location having physical block address PBA11. As explained below, the memory location at the physical block address PBA11 is the head of a temporary spare memory section. The circular sequential address redirection logic 69 of the repetitive address indirection control logic 68, performs (block 334, FIG. 4a) the received write operation at the head of the spare temporary memory which is at the selected next-in-sequence physical address, which in this example is the memory location having physical block address PBA11. Thus, for every received write operation, the circular sequential address redirection logic 69 automatically increments the head address pointer 330 to point to the next-in-sequence physical address of the circular sequence of physical addresses. In this manner, successive received write operations are repetitively redirected to different physical addresses in a circular sequence of physical addresses to uniformly distribute write operations over the memory.

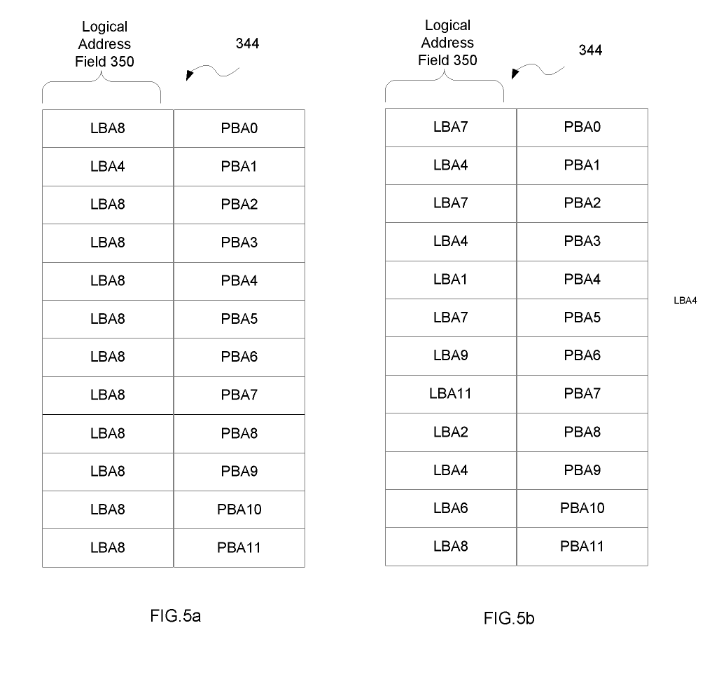

The repetitive address indirection control logic 68 (FIG. 2) further includes circular sequential address mapping logic 70 configured to map (block 340, FIG. 4a) the logical address of the received write operation to the selected next-in-sequence physical address at which the data of the write operation was written as described above. FIG. 5a depicts an example of data structure 344 for storing a mapping of logical addresses to the physical block addresses PBA0-PBA11 of the memory block 300 (FIGS. 3a, 3b). In one embodiment, the data structure 344 may be organized as flat indirection lookup table, for example. In the example of FIGS. 3a, 3b, the data of the received (block 310, FIG. 4a) write operation is directed to a logical address such as logical address LBA8, for example.

As described above, the circular sequential address redirection logic 69 of the repetitive address indirection control logic 68, performs (block 334, FIG. 4a) the received write operation at the selected next-in-sequence physical address, which in this example is the memory location having physical block address PBA11. In this manner, write data is written to physical addresses in the memory by repetitively redirecting each received write operation to a different physical address in the repeating circular sequence of physical block addresses PBA0, PBA1, . . . PBA11 independently of the logical address (LBA8 in this example) of each write operation. The circular sequential address mapping logic 70 updates a logical address field 350 of the data structure 344 to map (block 340, FIG. 4a) the logical address (LBA8 in this example) of the received write operation to the selected next-in-sequence physical address (PBA11 in this example) at which the data of the write operation was written as described above. If the same logical address was previously mapped to a different memory location in a previous write operation, the prior mapping may be suitably designated as no longer valid.

In another aspect of the present description, the repetitive address indirection control logic 68 is configured to set aside a section of the block 300 of memory locations as temporary spare memory section. In the example of FIGS. 3a, 3b, the temporary spare memory section is represented by the memory locations PBA11, PBA0, PBA1 as indicated by the cross-hatching of these memory locations. In one embodiment, any valid data in memory locations positioned within the temporary spare memory section, is relocated in advance of the write operations directed to the physical addresses indicated by the head address pointer 330. The relocation of valid data in advance of memory write operations is referred to herein as “cleaning” memory locations of the temporary spare memory section. Accordingly, a determination (block 360, FIG. 4a) is made as to whether additional memory locations are to be cleaned. If so, spare memory location cleaning operations are invoked (block 364). If additional write operations are subsequently received (block 310), the subsequent write operations are performed employing repetitive address indirection as described above.

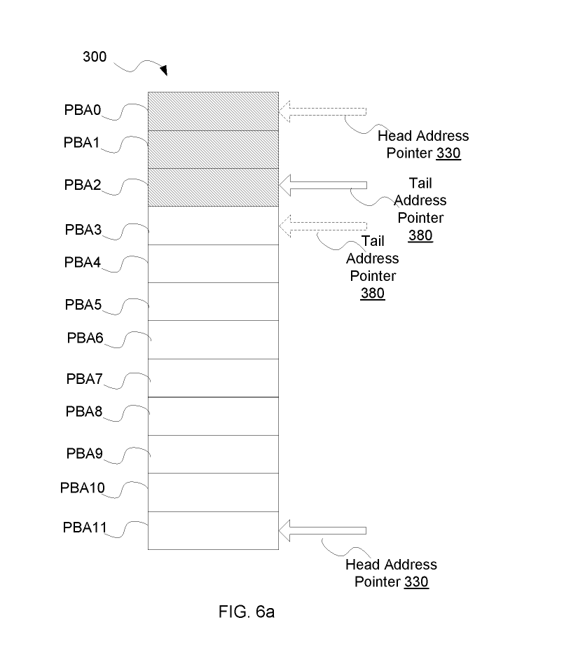

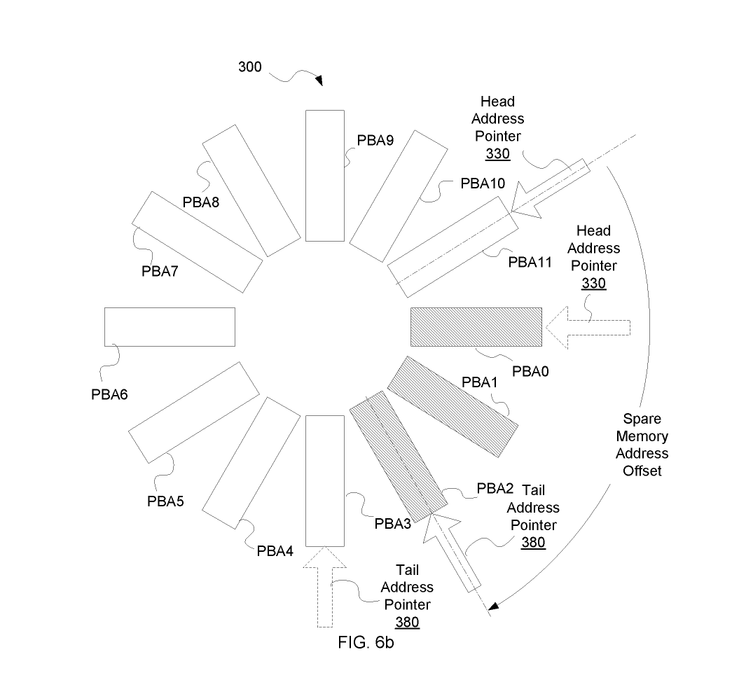

Accordingly, in connection with the receipt (block 310, FIG. 4a) of another write operation, which may be directed to the same logical address LBA8, for example, as the prior received write operation, a next-in-sequence physical address of the circular sequence of physical addresses of the memory is selected (block 314, FIG. 4a). In the example of FIGS. 6a, 6b the head address pointer 330 is shown pointing to the memory location having physical block address PBA11 indicating that the last write operation wrote data in the memory location having physical block address PBA11 as described above. The circular sequential address redirection logic 69 of the repetitive address indirection control logic 68, increments (block 314, FIG. 4a) the head address pointer 330 to point to the next-in-sequence physical address of the circular sequence of physical addresses. In the example of FIGS. 6a, 6b the head address pointer 330 as represented by the arrow depicted in phantom, is incremented to point to the next-in-sequence physical address of the circular sequence of physical addresses, which in this example is the memory location having physical block address PBA0. The circular sequential address redirection logic 69 of the repetitive address indirection control logic 68, performs (block 334, FIG. 4a) the received write operation at the selected next-in-sequence physical address, which in this example is the memory location having physical block address PBA0, notwithstanding that the logical address, LBA8 in this example, has remained unchanged for the last two write operations. In this manner, write data is written to physical addresses in the memory in the repeating circular sequence of physical block addresses independently of the logical address (LBA8 in these two examples) of each write operation. The circular sequential address mapping logic 70 updates a logical address field 350 of the data structure 344 to map (block 340, FIG. 4a) the logical address (LBA8 in this example) of the received write operation to the selected next-in-sequence physical address (PBA0 in this example) at which the data of the write operation was written as described above.

In connection with the receipt (block 310, FIG. 4a) of yet another write operation, which may be directed to another logical address such as LBA4, for example, a next-in-sequence physical address of the circular sequence of physical addresses of the memory is selected (block 314, FIG. 4a). Accordingly, the circular sequential address redirection logic 69 of the repetitive address indirection control logic 68, unconditionally increments (block 314, FIG. 4a) the head address pointer 330 to point to the next-in-sequence physical address of the circular sequence of physical addresses. The head address pointer is incremented to point to the next-in-sequence physical address of the circular sequence of physical addresses, which in this example is the memory location having physical block address PBA1. The circular sequential address redirection logic 69 of the repetitive address indirection control logic 68, performs (block 334, FIG. 4a) the received write operation at the selected next-in-sequence physical address, which in this example is the memory location having physical block address PBA1, independently of the logical address, LBA4 to which the write operation is directed. In this manner, write data is written to physical addresses in the memory in the repeating circular sequence of physical block addresses PBA0, PBA1, . . . PBA11 independently of the logical address of each write operation. The circular sequential address mapping logic 70 updates a logical address field 350 of the data structure 344 to map (block 340, FIG. 4a) the logical address (LBA4 in this example) of the received write operation to the selected next-in-sequence physical address (PBA1 in this example) at which the data of the write operation was written as described above. Accordingly, FIG. 5a indicates the selected next-in-sequence physical address (PBA1 in this example) as being mapped to the logical address LBA4 in this example.

Thus, in a memory employing repetitive address indirection in accordance with one aspect of the present description, write data for every write operation is automatically and repetitively redirected to physical addresses in a memory in a circular sequence of physical addresses such that the write operations are automatically evenly distributed over the memory. FIG. 5a represents an example of a string of write repeating operations, all directed to a single logical address, logical address LBA8, for example, with the exception of the write operation directed to physical address PBA1 and mapped to logical address LBA4 as shown in FIG. 5a. Notwithstanding that all but one write operation is directed to the same logical address, the actual write operations are evenly distributed over the physical addresses PBA0-PBA11 of the memory as shown in FIG. 5a. As a result, wear leveling logic may be reduced or eliminated. For example, write access cycle count logic which previously tracked the number of memory write access cycles for each memory location, may be reduced or eliminated. In addition, memory location redistribution logic which selected the relocation destinations to more evenly distribute the write operations when the threshold was exceed, may also be reduced or eliminated. Instead, in one embodiment, the physical address may be simply incremented for each incoming write operation, and the logical address of the write operation may be mapped to the incremented physical address as shown in FIG. 5a. Thus, complex redistribution algorithms may be eliminated.

Further, in a memory employing repetitive address indirection in accordance with one aspect of the present description, write data is written to physical addresses in a memory in a circular sequence of physical addresses such that each potential victim location is automatically updated before needing a refresh. For example, in a write operation directed to physical address PBA1, for example, the adjacent memory location at physical address PBA2 is potentially, absent repetitive address indirection in accordance with one aspect of the present description, a potential write victim. However, because the memory location at physical address PBA2 is automatically updated in the next write operation because the physical address PBA2 is the next-in-sequence physical address of the circular sequence of physical addresses, the next-in-sequence physical address PBA2 is automatically updated before needing a refresh.

Similarly, in the write operation directed to physical address PBA1, for example, the adjacent memory location at physical address PBA0 is, absent repetitive address indirection in accordance with one aspect of the present description, potentially a write victim. However, because the next-in-sequence memory location written for the next write operation is at physical address PBA2 instead of the previous memory location PBA1 adjacent to the potential write victim PBA0, the potential write victim PBA0 is no longer adjacent to the memory location being updated. Accordingly, the memory location PBA0 is no longer a potential write victim and does not need a refresh to avoid becoming a write victim.

Consequently, write victim refresh logic of prior memory management logic which tracked potential write victims may be reduced or eliminated. In addition, write victim refresh metadata storing the write access cycle count and write victim refresh threshold value for each memory location may be reduced or eliminated as well. As a result, the amount of memory available for storing user data may be increased without increasing the size of the memory.

Still further, in a memory employing repetitive address indirection in accordance with one aspect of the present description, each page of memory automatically has an equal or substantially equal number of memory operation write access cycles because write data is written to physical addresses in a memory in a circular sequence of physical addresses to automatically evenly distribute write operations over the memory as shown in FIG. 5a. As a result, the likelihood of any one memory location prematurely exceeding the maximum write access cycle threshold, is reduced or eliminated. Further, memory location mapping rotation logic of prior memory management logic may be reduced or eliminated. In addition, the consumption of resources by such prior memory location mapping rotation logic, may be reduced or eliminated as well.

As previously mentioned, in one embodiment, the repetitive address indirection control logic 68 is configured to set aside a section of the block 300 of memory locations as temporary spare memory section. In the example of FIGS. 3a, 3b, the temporary spare memory section is represented by the memory locations PBA11, PBA0, PBA1 as indicated by the cross-hatching of these memory locations.

As discussed above, a determination (block 360, FIG. 4a) is made as to whether additional memory locations are to be cleaned to relocate any valid data in advance of approaching circular sequential write operations. If so, spare memory location cleaning operations are invoked (block 364) to clean one or more memory locations. FIG. 4b depicts one example of operations to clean memory locations of the temporary spare memory section of the block 300 of memory locations.

In the illustrated embodiment, the circular sequential address redirection logic 69 (FIG. 2) is further configured to select (block 370, FIG. 4b) an offset next-in-sequence physical address of the circular sequence of physical addresses of the memory. For example, in one embodiment, the circular sequential address redirection logic 70 (FIG. 2) further has a tail address pointer data structure 374 configured to store a tail address pointer 380 (FIGS. 3a, 3b) as represented by a tail address pointer arrow. In the example of FIGS. 3a, 3b the tail address pointer 380 is shown initially pointing to the memory location having physical block address PBA1. The tail address pointer 380 is initially offset from the head address pointer 330 by a predetermined number of memory locations which defines the initial size of the spare memory. Thus, in the example of FIGS. 3a, 3b, the tail address pointer 380 is initially offset from the head address pointer 330 by three memory locations (PBA11, PBA0, PBA1) which defines the initial size of the spare memory as three memory locations which in the example of FIGS. 3a, 3b comprise the memory locations PBA11, PBA0, PBA1.

To select (block 370, FIG. 4b) an offset next-in-sequence physical address of a circular sequence of physical addresses of the memory, the circular sequential address redirection logic 70 of the repetitive address indirection control logic 68, is further configured to increment (block 370, FIG. 4b) the tail address pointer 380 to point to the offset next-in-sequence physical address of the circular sequence of physical addresses. In the example of FIGS. 3a, 3b the tail address pointer 380 as represented by the arrow pointing to physical address PBA1, is incremented to point to the offset next-in-sequence physical address of the circular sequence of physical addresses, which in this example is the memory location having physical block address PBA2, as represented by the tail address pointer arrow depicted in phantom pointing to the physical block address PBA2.

The circular sequential address redirection logic 69 (FIG. 2) is configured to “clean” the memory location at a memory physical address pointed to by the tail address pointer 380 and prepare the memory location to receive another write operation when the head address pointer is subsequently incremented to point to that location. As used herein, a memory location is cleaned if it is determined that the memory location contains valid data, and if so, the valid data is relocated to another memory location to preserve the valid data from being overwritten by the writing of write data to physical addresses pointed to by the head address pointer in the circular sequence of physical addresses of the memory. Accordingly, in one embodiment, the circular sequential address redirection logic 69 (FIG. 2) is configured to determine (block 384, FIG. 4b) whether there is valid data at the selected offset next-in-sequence physical address of the circular sequence, which is the memory location having physical address PBA2 in the example of FIG. 3a, 3b. If so, a write operation is invoked (block 390, FIG. 4b) to relocate the valid data at the selected offset next-in-sequence physical address (PBA2 in this example) to a different memory location. If additional spare memory locations are to be cleaned (block 394), the operations of FIG. 4b are repeated.

It is appreciated that valid write data may be relocated to a variety of different locations, depending upon the particular application. For example, in one embodiment, valid data being cleaned (FIG. 4b) from the spare memory may be relocated to a memory location within the block 300 (FIG. 3a, 3b) of memory locations. Accordingly, the write operation invoked (block 390, FIG. 4b) to relocate the valid data at the selected offset next-in-sequence physical address (PBA2 in this example) to a different memory location, may be a write operation of FIG. 4a employing repetitive address indirection in accordance with the present description.

Accordingly, in connection with the receipt (block 310, FIG. 4a) of the relocation write operation (block 390, FIG. 4b), a next-in-sequence physical address of the circular sequence of physical addresses of the memory is selected (block 314, FIG. 4a). In the example of FIGS. 6a, 6b the head address pointer 330 is shown pointing to the memory location having physical block address PBA11 indicating that the last write operation wrote data in the memory location having physical block address PBA11. The circular sequential address redirection logic 70 of the repetitive address indirection control logic 68, increments (block 314, FIG. 4a) the head address pointer 330 to point to the next-in-sequence physical address of the circular sequence of physical addresses. In the example of FIGS. 6a, 6b the head address pointer 330 as represented by the arrow depicted in phantom, is incremented to point to the next-in-sequence physical address of the circular sequence of physical addresses, which in this example is the memory location having physical block address PBA0. The circular sequential address redirection logic 70 of the repetitive address indirection control logic 68, performs (block 334, FIG. 4a) the received write operation and rewrites the valid data which had been located at the memory location having the physical address PBA2, to the memory location at the selected next-in-sequence physical address, which in this example is the memory location having physical block address PBA0.

In this example, the valid data which had been located at the memory location having the physical address PBA2, had been mapped to logical address LBA7 as shown in FIG. 5b. The circular sequential address mapping logic 70 updates a logical address field 350 of the data structure 344 to map (block 340, FIG. 4a) the logical address (LBA7 in this example) of the received write operation to the selected next-in-sequence physical address (PBA0 in this example) at which the data of the write operation was relocated as described above. The prior mapping of the logical address LBA7 to the memory location PBA2 prior to the relocation of the valid data previously stored there, may be suitably designated as no longer valid in view of the relocation of the valid data to memory location PBA0.

In an alternative embodiment, valid data being cleaned (FIG. 4b) from the spare memory may be relocated to a memory location outside the block 300 (FIG. 3a, 3b) of memory locations, to memory locations in an alternate memory. Accordingly, the write operation invoked (block 390, FIG. 4b) to relocate the valid data at the selected offset next-in-sequence physical address (PBA2 in this example) to a different memory location, may be a write operation directed to an alternate memory such as storage of the peripheral components 50 which may be, for example, non-volatile storage, such as solid-state drives, magnetic disk drives, optical disk drives, a tape drive, flash memory, etc. In one embodiment, a hybrid memory device may employ as an alternate memory, a relatively slow non-volatile memory such as NAND flash memory for example, for the majority of the memory capacity of the hybrid device, and as a relatively fast frontend as represented by the block 300, a relatively fast non-volatile memory such as a crosspoint memory for example. In some embodiments, the alternate memory may also employ repetitive address indirection in accordance with the present description.

It is appreciated that the illustrated embodiment may have a four times worse write amplification compared to typical garbage collection scheme used in solid state drives (SSDs) that include NAND memory. In one embodiment, the memory media may have an offsetting four times greater endurance. It is further appreciated that improved performance may be achieved by employing smaller write granularity.

FIG. 4c depicts one example of operations of a memory employing repetitive address indirection in accordance with one embodiment of the present description, for addressing potential read disturb phenomenon. In this embodiment, the repetitive address indirection control logic 68 (FIG. 2) is further configured to receive a plurality of read operations for reading data from a logical address of the memory, and to selectively relocate the read data to a next-in-sequence physical address of the circular sequence of physical addresses of the memory. Accordingly, in connection with the receipt (block 400, FIG. 4c) of one or more read operations from a host, a core, or a DMA controller, for example, a determination (block 410) is made as to whether the read data being addressed by a read operation should be relocated. Such a determination to selectively relocate read data may be made using known statistical analysis techniques, for example. Upon a determination (block 410) that the read data being addressed by a read operation should be relocated, a write operation is invoked (block 414) to relocate the read data to a different location. The invocation (block 414) of a write operation to relocate the read data to a different location, may be similar to the invocation (block 390, FIG. 4b) discussed above of a write operation to relocate the valid data at a selected offset next-in-sequence physical address of the spare temporary memory section to a different memory location, for purposes of cleaning the selected offset next-in-sequence physical address of the spare temporary memory section.

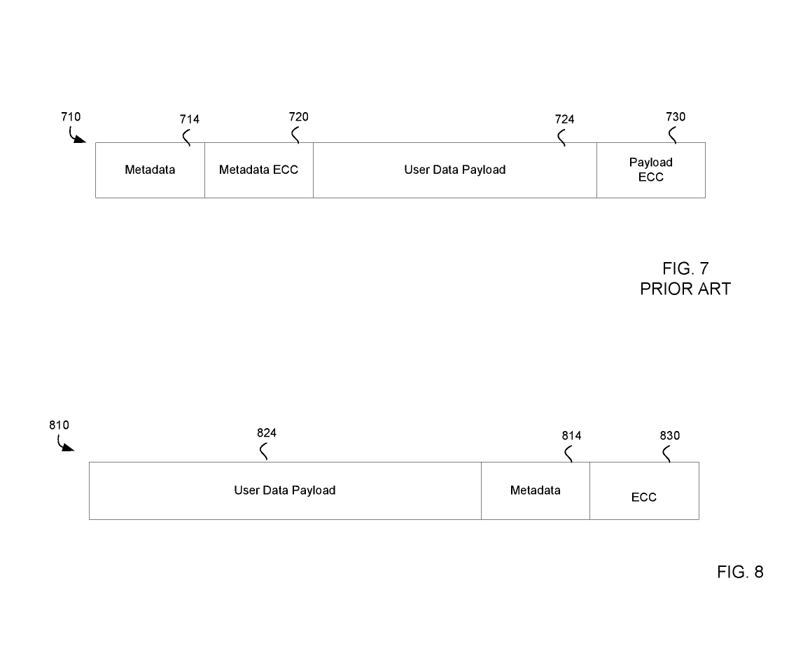

As previously mentioned, unconditional repetitive address indirection in accordance with the present description may provide for not only a reduction in logic circuitry and programming previously employed for conditional, nonsequential memory access redirection and refresh operations, but also provide a reduction in metadata and associated error correction codes previously stored in each memory location for bitcell and data preservation purposes. FIG. 7 shows an example of a memory 710 having a prior art arrangement of metadata, error correction code (ECC) and user payload fields including a metadata field 714, a metadata ECC field 720, a user data payload field 724 and a payload ECC field 730. In this example, the metadata field 714 includes metadata for bitcell and data preservation purposes including metadata for conditional, nonsequential redirection of memory accesses such as metadata for write access cycle or write victim (or write disturb) counts being tracked for that memory location, for example. Thus, the metadata field 714 may contain metadata for both the logical location associated with a particular physical location, but may also contain metadata related to the physical location itself. Accordingly, memory management logic performing data preservation operations directed to write victim or write disturb avoidance may update only metadata affecting the physical location. Hence, the metadata field 714 and its associated metadata ECC field 720 may be packaged in a separate packet which is separately accessible for read and write operations directed to the separate packet of the metadata field 714 and its associated metadata ECC field 720. For example, logic such as write victim refresh logic which compares a write victim refresh threshold value to a write access cycle count, may access the separate packet of the metadata field 714 and its associated metadata ECC field 720, separate and apart from the user data payload field 724 and payload ECC field 730 of a particular memory location, to reduce the impact of wear leveling and other bitcell protection and data preservation operations.

In contrast, in a memory employing unconditional, repetitive address indirection, in accordance with the present description, such separate packet metadata for conditional, nonsequential memory access redirection and data protection may be reduced or eliminated. For example, FIG. 8 shows an example of a memory location 810 which includes a metadata field 814 configured to store metadata, a user data payload field 824 configured to store user data, and a single error correction code (ECC) field 830 configured to store an encoding of the entire memory location for error detection and correction. Accordingly, the memory location 810 has a single, consolidated packet storing the metadata field 814, user data payload field 824, and the single error correction code (ECC) field 830. Thus, the memory location 810 lacks the multiple separate packets of the memory location 710 (FIG. 7).

In this example, the metadata field 814 lacking the metadata for conditional, nonsequential memory access redirection employed for the memory location 710 (FIG. 7), has a size of 12 bytes. By comparison, the metadata field 714 (FIG. 7) storing metadata for conditional, nonsequential bitcell and data preservation purposes including for example, write access cycle counts being tracked for the memory location 710, has a size of 16 bytes. Accordingly, a memory employing repetitive access indirection in accordance with the present description may have increased capacity for storing additional user data without increasing the overall capacity of the memory.

As noted above, previous memories frequently employed logic to read and update the metadata field 714 separately from the user data payload field 724 and its associated payload ECC field 730. Accordingly, the metadata field 714 in previous memories frequently employed a separate ECC field 720 to detect and correct metadata storage errors when reading from or writing to the metadata field 714 for the bitcell and data preservation operations. Accordingly, logic was provided for both read and write operations to the metadata field 714 and the metadata ECC field 720 independently of read and write operations to the user data payload field 724 and payload ECC field 730 for the memory location 710.

By comparison, since the metadata field 814 (FIG. 8) lacks the metadata for conditional, nonsequential redirection of memory access, employed in the metadata field 714 of the memory location 710 of FIG. 7, logic for separately reading from or writing to the metadata field 814 may be reduced or eliminated. Moreover, by eliminating both the metadata for conditional, nonsequential redirection of memory accesses employed in the metadata field 714 of the memory location 710 of FIG. 7, and the associated logic provided for both separate read and write operations to the metadata field 714 and the metadata ECC field 720, the separate metadata ECC field 720 of the memory location 710 of FIG. 7 may be reduced or eliminated. In the example of FIG. 7, the metadata field 714 is 16 bytes in size, the metadata ECC field 720 is 16 bytes in size and the separate payload ECC field 730 is 128 bytes in size for a total of 160 bytes of overhead data which is 15.6% of the user data payload of 1024 bytes.

In contrast, in the memory location 810, a single ECC field encodes the entire memory location 310 including the user data payload field 824 and the metadata field 814. By eliminating the separate metadata ECC field 720 of the prior memory location 710 of FIG. 7, the single ECC data field 830 of the memory location 810 of a memory employing repetitive access indirection in accordance with the present description, may have a smaller total size of 112 bytes for example, and yet provide the same level of error detection and correction (such as 6e-4 raw bit error rate (RBER), for example) for the metadata field 814 and user data payload field 824. Moreover, in the example of FIG. 8, the metadata field 814 is 12 bytes in size, and the ECC field 830 is 112 bytes in size for a total of 124 bytes of overhead data which is 12.5% of the user data payload of 1024 bytes, representing a 3.1% reduction in overhead as compared to the overhead of the memory location 710 of FIG. 7. Thus, in a 32 gigabyte (GB) nonvolatile memory die, for example, 2800 megabytes (MB) of user capacity would be exposed in a memory employing repetitive address indirection in accordance with the present description as compared to 2700 MB in a memory employing a prior conditional, nonsequential access indirection scheme. It is appreciated that the particular arrangement and sizes of user payload data, metadata and error correction detection and correction fields, may vary in a memory employing repetitive address indirection in accordance with the present description, depending upon the particular application.

### EXAMPLES

The following examples pertain to further embodiments.

Example 1 is an apparatus comprising: a non-volatile memory, said memory including: a plurality of memory locations, each memory location configured to store data and having a physical address, and repetitive address indirection control logic configured to receive a plurality of write operations for writing data to logical addresses of the memory, and further configured to repetitively redirect the writing of write data of the write operations to physical addresses in the memory in a circular sequence of physical addresses of the memory independently of logical addresses of the write operations, said repetitive address indirection control logic including: circular sequential address redirection logic configured to, for every received write operation of the plurality of write operations, select a next-in-sequence physical address of the circular sequence of physical addresses of the memory, and perform the received write operation at the selected next-in-sequence physical address, wherein the circular sequence of physical addresses starts at a beginning physical address of the circular sequence, ends at an ending physical address of the circular sequence of physical addresses and includes physical addresses intermediate the beginning and ending physical addresses of the circular sequence, and circular sequential address mapping logic configured to map a logical address of each received write operation to the selected next-in-sequence physical address, and wherein the circular sequential address redirection logic is further configured to, if a selected next-in-sequence physical address is the ending physical address of the circular sequence of physical addresses, restart the circular sequence of physical addresses so that the next-in-sequence physical address to be selected is the beginning physical address of the circular sequence of physical addresses.

In Example 2, the subject matter of Examples 1-9 (excluding the present Example) can optionally include wherein the circular sequential address redirection logic configured to select a next-in-sequence physical address of a circular sequence of physical addresses, has a head address pointer data structure configured to store a head address pointer, and is further configured to increment the head address pointer to point to the next-in-sequence physical address of the circular sequence of physical addresses, and to write the data of a received write operation to the next-in-sequence circular memory physical address pointed to by the head address pointer.

In Example 3, the subject matter of Examples 1-9 (excluding the present Example) can optionally include wherein the circular sequential address redirection logic further has a tail address pointer data structure configured to store a tail address pointer, and wherein the circular sequential address redirection logic is further configured to, in connection with incrementing the head address pointer to point to the next-in-sequence circular memory physical address of the circular sequence of physical addresses, increment the tail address pointer to point to an offset next-in-sequence physical address of the circular sequence of physical addresses, wherein the offset next-in-sequence physical address pointed to by the tail address pointer is offset from the next-in-sequence physical address pointed to by the head address pointer by a predetermined number of physical addresses.

In Example 4, the subject matter of Examples 1-9 (excluding the present Example) can optionally include wherein the circular sequential address redirection logic is further configured to, in connection with the incrementing a tail address pointer to point to an offset next-in-sequence physical address, to increment the tail address pointer to pointing to a current tail address pointer physical address, to point to an offset next-in-sequence physical address, and wherein the repetitive address indirection control logic is further configured to relocate valid data located at the offset next-in-sequence physical address to another memory location to preserve the valid data from being overwritten by the writing of write data to physical addresses in the memory in a circular sequence of physical addresses of the memory.

In Example 5, the subject matter of Examples 1-9 (excluding the present Example) can optionally include wherein the circular sequential address redirection logic is further configured to increment the head address pointer to point to the next-in-sequence physical address of the circular sequence of physical addresses so that valid data located at a current tail address pointer physical address is written to the next-in-sequence circular memory physical address pointed to by the head address pointer, to relocate the valid data located at the current tail address pointer physical address to the next-in-sequence circular memory physical address pointed to by the head address pointer.

In Example 6, the subject matter of Examples 1-9 (excluding the present Example) can optionally include a temporary spare memory section provided by the memory locations of the physical addresses of the circular sequence of physical addresses between the physical address pointed to by the head address pointer and the physical address pointed to by the tail address pointer, and wherein the next-in-sequence circular memory physical address pointed to by the head address pointer is at the head of the temporary spare memory section.

In Example 7, the subject matter of Examples 1-9 (excluding the present Example) can optionally include wherein the repetitive address indirection control logic is further configured to receive a plurality of read operations for reading data from a logical address of the memory, and to selectively relocate the read data to a next-in-sequence physical address of the circular sequence of physical addresses of the memory, and wherein the circular sequential address mapping logic is further configured to map the logical address of the read operations to the next-in-sequence physical address of the read data relocation.

In Example 8, the subject matter of Examples 1-9 (excluding the present Example) can optionally include wherein each memory location includes a metadata field configured to store metadata, a user data payload field configured to store user data, and a single error correction code field configured to store an encoding of the entire memory location for error detection and correction.

In Example 9, the subject matter of Examples 1-9 (excluding the present Example) can optionally a computing system comprising: said non-volatile memory, a processor configured to cause a data write into or data read from the memory, and any of:

a display communicatively coupled to the processor, a network interface communicatively coupled to the processor, or a battery coupled to provide power to the system.

Example 10 is a method, comprising: receiving a plurality of write operations directed to logical addresses of a non-volatile memory, and writing data of received write operations to physical addresses in the memory, said writing including repetitively redirecting the writing of write data of the plurality of write operations to physical addresses in the memory in a circular sequence of physical addresses of the memory, wherein for each received write operation of the plurality of write operations, the writing of data includes: selecting a next-in-sequence physical address of the circular sequence, performing a write operation at a selected physical address, mapping the logical address to a selected physical address, and if a selected physical address is an ending address of the circular sequence, restarting the circular sequence so that the next-in-sequence physical address to be selected is a beginning physical address of the circular sequence of physical addresses.

In Example 11, the subject matter of Examples 10-17 (excluding the present Example) can optionally include wherein the selecting a next-in-sequence physical address of a circular sequence of physical addresses includes incrementing a head address pointer to point to the next-in-sequence physical address of the circular sequence of physical addresses so that the write data of a received write operation is written to the next-in-sequence physical address pointed to by the head address pointer.

In Example 12, the subject matter of Examples 10-17 (excluding the present Example) can optionally include in connection with incrementing a head address pointer to point to the next-in-sequence circular memory physical address of the circular sequence of physical addresses, incrementing a tail address pointer to point to an offset next-in-sequence physical address of the circular sequence of physical addresses, wherein the offset next-in-sequence physical address pointed to by the tail address pointer is offset from the next-in-sequence physical address pointed to by the head address pointer by a predetermined number of physical addresses.

In Example 13, the subject matter of Examples 10-17 (excluding the present Example) can optionally include wherein the incrementing a tail address pointer to point to an offset next-in-sequence physical address includes incrementing a tail address pointer pointing to a current tail address pointer physical address, to point to an offset next-in-sequence physical address, and wherein the method further includes relocating valid data located at the offset next-in-sequence physical address to another memory location to preserve the valid data from being overwritten by the writing of write data to physical addresses in the memory in a circular sequence of physical addresses of the memory.

In Example 14, the subject matter of Examples 10-17 (excluding the present Example) can optionally include wherein relocating valid data located at a current tail address pointer physical address to another memory location includes incrementing the head address pointer to point to the next-in-sequence physical address of the circular sequence of physical addresses so that the data being relocated is written to the next-in-sequence circular memory physical address pointed to by the head address pointer.

In Example 15, the subject matter of Examples 10-17 (excluding the present Example) can optionally include wherein the physical addresses of the circular sequence of physical addresses between the physical address pointed to by the head address pointer and the physical address pointed to by the tail address pointer provide a temporary spare memory section of the memory, the method further comprising relocating valid data of the temporary spare memory section.

In Example 16, the subject matter of Examples 10-17 (excluding the present Example) can optionally include receiving a plurality of read operations for reading data from a logical address of the memory, selectively relocating the read data to a next-in-sequence physical address of the circular sequence of physical addresses of the memory, and mapping the logical address of the read operations to the next-in-sequence physical address of the read data relocation.

In Example 17, the subject matter of Examples 10-17 (excluding the present Example) can optionally include for each memory location, storing metadata in a metadata field, user data in a user data payload field, and an encoding of the entire memory location for error detection and correction, in a single error correction code field.

Example 18 is a memory apparatus comprising means to perform a method as claimed in any preceding claim.

Example 19 is a computing system, comprising: a memory, and a processor configured to cause a data write into or data read from the memory, wherein the memory is a non-volatile memory, said memory including: a plurality of memory locations, each memory location configured to store data and having a physical address, and repetitive address indirection control logic configured to receive a plurality of write operations for writing data to logical addresses of the memory, and further configured to repetitively redirect the writing of write data of the write operations to physical addresses in the memory in a circular sequence of physical addresses of the memory independently of logical addresses of the write operations, said repetitive address indirection control logic including: circular sequential address redirection logic configured to, for every received write operation of the plurality of write operations, select a next-in-sequence physical address of the circular sequence of physical addresses of the memory, and perform the received write operation at the selected next-in-sequence physical address, wherein the circular sequence of physical addresses starts at a beginning physical address of the circular sequence, ends at an ending physical address of the circular sequence of physical addresses and includes physical addresses intermediate the beginning and ending physical addresses of the circular sequence, and circular sequential address mapping logic configured to map a logical address of each received write operation to the selected next-in-sequence physical address, and wherein the circular sequential address redirection logic is further configured to, if a selected next-in-sequence physical address is the ending physical address of the circular sequence of physical addresses, restart the circular sequence of physical addresses so that the next-in-sequence physical address to be selected is the beginning physical address of the circular sequence of physical addresses.

In Example 20, the subject matter of Examples 19-27 (excluding the present Example) can optionally include wherein the circular sequential address redirection logic configured to select a next-in-sequence physical address of a circular sequence of physical addresses, has a head address pointer data structure configured to store a head address pointer, and is further configured to increment the head address pointer to point to the next-in-sequence physical address of the circular sequence of physical addresses, and to write the data of a received write operation to the next-in-sequence circular memory physical address pointed to by the head address pointer.

In Example 21, the subject matter of Examples 19-27 (excluding the present Example) can optionally include wherein the circular sequential address redirection logic further has a tail address pointer data structure configured to store a tail address pointer, and wherein the circular sequential address redirection logic is further configured to, in connection with incrementing the head address pointer to point to the next-in-sequence circular memory physical address of the circular sequence of physical addresses, increment the tail address pointer to point to an offset next-in-sequence physical address of the circular sequence of physical addresses, wherein the offset next-in-sequence physical address pointed to by the tail address pointer is offset from the next-in-sequence physical address pointed to by the head address pointer by a predetermined number of physical addresses.

In Example 22, the subject matter of Examples 19-27 (excluding the present Example) can optionally include wherein the circular sequential address redirection logic is further configured to, in connection with the incrementing a tail address pointer to point to an offset next-in-sequence physical address, to increment the tail address pointer to pointing to a current tail address pointer physical address, to point to an offset next-in-sequence physical address, and wherein the repetitive address indirection control logic is further configured to relocate valid data located at the offset next-in-sequence physical address to another memory location to preserve the valid data from being overwritten by the writing of write data to physical addresses in the memory in a circular sequence of physical addresses of the memory.

In Example 23, the subject matter of Examples 19-27 (excluding the present Example) can optionally include wherein the circular sequential address redirection logic is further configured to increment the head address pointer to point to the next-in-sequence physical address of the circular sequence of physical addresses so that valid data located at a current tail address pointer physical address is written to the next-in-sequence circular memory physical address pointed to by the head address pointer, to relocate the valid data located at the current tail address pointer physical address to the next-in-sequence circular memory physical address pointed to by the head address pointer.

In Example 24, the subject matter of Examples 19-27 (excluding the present Example) can optionally include a temporary spare memory section provided by the memory locations of the physical addresses of the circular sequence of physical addresses between the physical address pointed to by the head address pointer and the physical address pointed to by the tail address pointer, and wherein the next-in-sequence circular memory physical address pointed to by the head address pointer is at the head of the temporary spare memory section.

In Example 25, the subject matter of Examples 19-27 (excluding the present Example) can optionally include wherein the repetitive address indirection control logic is further configured to receive a plurality of read operations for reading data from a logical address of the memory, and to selectively relocate the read data to a next-in-sequence physical address of the circular sequence of physical addresses of the memory, and wherein the circular sequential address mapping logic is further configured to map the logical address of the read operations to the next-in-sequence physical address of the read data relocation.

In Example 26, the subject matter of Examples 19-27 (excluding the present Example) can optionally include wherein each memory location includes a metadata field configured to store metadata, a user data payload field configured to store user data, and a single error correction code field configured to store an encoding of the entire memory location for error detection and correction.

In Example 27, the subject matter of Examples 19-27 (excluding the present Example) can optionally include any of: a display communicatively coupled to the processor, a network interface communicatively coupled to the processor, or a battery coupled to provide power to the system.

Example 28 is an apparatus for storing data, comprising: a non-volatile memory, said memory including: a plurality of memory locations, each memory location configured to store data and having a physical address, and repetitive address indirection control means for receiving a plurality of write operations for writing data to logical addresses of the memory, and for repetitively redirecting the writing of write data of the write operations to physical addresses in the memory in a circular sequence of physical addresses of the memory independently of logical addresses of the write operations, said repetitive address indirection control means including: circular sequential address redirection means for, for every received write operation of the plurality of write operations, selecting a next-in-sequence physical address of the circular sequence of physical addresses of the memory, and performing the received write operation at the selected next-in-sequence physical address, wherein the circular sequence of physical addresses starts at a beginning physical address of the circular sequence, ends at an ending physical address of the circular sequence of physical addresses and includes physical addresses intermediate the beginning and ending physical addresses of the circular sequence, and circular sequential address mapping means for mapping a logical address of each received write operation to the selected next-in-sequence physical address, and wherein the circular sequential address redirection means is further for, if a selected next-in-sequence physical address is the ending physical address of the circular sequence of physical addresses, restarting the circular sequence of physical addresses so that the next-in-sequence physical address to be selected is the beginning physical address of the circular sequence of physical addresses.

In Example 29, the subject matter of Examples 28-36 (excluding the present Example) can optionally include wherein the circular sequential address redirection means for selecting a next-in-sequence physical address of a circular sequence of physical addresses, has a head address pointer data structure configured to store a head address pointer, and is further for incrementing the head address pointer to point to the next-in-sequence physical address of the circular sequence of physical addresses, and for writing the data of a received write operation to the next-in-sequence circular memory physical address pointed to by the head address pointer.

In Example 30, the subject matter of Examples 28-36 (excluding the present Example) can optionally include wherein the circular sequential address redirection means further has a tail address pointer data structure configured to store a tail address pointer, and wherein the circular sequential address redirection means is further for, in connection with incrementing the head address pointer to point to the next-in-sequence circular memory physical address of the circular sequence of physical addresses, incrementing the tail address pointer to point to an offset next-in-sequence physical address of the circular sequence of physical addresses, wherein the offset next-in-sequence physical address pointed to by the tail address pointer is offset from the next-in-sequence physical address pointed to by the head address pointer by a predetermined number of physical addresses.

In Example 31, the subject matter of Examples 28-36 (excluding the present Example) can optionally include wherein the circular sequential address redirection means is further for, in connection with the incrementing a tail address pointer to point to an offset next-in-sequence physical address, incrementing the tail address pointer pointing to a current tail address pointer physical address, to point to an offset next-in-sequence physical address, and wherein the repetitive address indirection control means is further for relocating valid data located at the offset next-in-sequence physical address to another memory location to preserve the valid data from being overwritten by the writing of write data to physical addresses in the memory in a circular sequence of physical addresses of the memory.

In Example 32, the subject matter of Examples 28-36 (excluding the present Example) can optionally include wherein the circular sequential address redirection means is further for incrementing the head address pointer to point to the next-in-sequence physical address of the circular sequence of physical addresses so that valid data located at a current tail address pointer physical address is written to the next-in-sequence circular memory physical address pointed to by the head address pointer, to relocate the valid data located at the current tail address pointer physical address to the next-in-sequence circular memory physical address pointed to by the head address pointer.

In Example 33, the subject matter of Examples 28-36 (excluding the present Example) can optionally include a temporary spare memory section provided by the memory locations of the physical addresses of the circular sequence of physical addresses between the physical address pointed to by the head address pointer and the physical address pointed to by the tail address pointer, and wherein the next-in-sequence circular memory physical address pointed to by the head address pointer is at the head of the temporary spare memory section.

In Example 34, the subject matter of Examples 28-36 (excluding the present Example) can optionally include wherein the repetitive address indirection control means is further for receiving a plurality of read operations for reading data from a logical address of the memory, and for selectively relocating the read data to a next-in-sequence physical address of the circular sequence of physical addresses of the memory, and wherein the circular sequential address mapping means is further for mapping the logical address of the read operations to the next-in-sequence physical address of the read data relocation.

In Example 35, the subject matter of Examples 28-36 (excluding the present Example) can optionally include wherein each memory location includes a metadata field configured to store metadata, a user data payload field configured to store user data, and a single error correction code field configured to store an encoding of the entire memory location for error detection and correction.

In Example 36, the subject matter of Examples 28-36 (excluding the present Example) can optionally include a computing system comprising: said non-volatile memory, a processor configured to cause a data write into or data read from the memory, and any of: a display communicatively coupled to the processor, a network interface communicatively coupled to the processor, or a battery coupled to provide power to the system.

The described operations may be implemented as a method, apparatus or computer program product using standard programming and/or engineering techniques to produce software, firmware, hardware, or any combination thereof. The described operations may be implemented as computer program code maintained in a “computer readable storage medium”, where a processor may read and execute the code from the computer storage readable medium. The computer readable storage medium includes at least one of electronic circuitry, storage materials, inorganic materials, organic materials, biological materials, a casing, a housing, a coating, and hardware. A computer readable storage medium may comprise, but is not limited to, a magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), Solid State Devices (SSD), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The program code embedded on a computer readable storage medium may be transmitted as transmission signals from a transmitting station or computer to a receiving station or computer. A computer readable storage medium is not comprised solely of transmissions signals. Those skilled in the art will recognize that many modifications may be made to this configuration without departing from the scope of the present description, and that the article of manufacture may comprise suitable information bearing medium known in the art. Of course, those skilled in the art will recognize that many modifications may be made to this configuration without departing from the scope of the present description, and that the article of manufacture may comprise any tangible information bearing medium known in the art.

In certain applications, a device in accordance with the present description, may be embodied in a computer system including a video controller to render information to display on a monitor or other display coupled to the computer system, a device driver and a network controller, such as a computer system comprising a desktop, workstation, server, mainframe, laptop, handheld computer, etc. Alternatively, the device embodiments may be embodied in a computing device that does not include, for example, a video controller, such as a switch, router, etc., or does not include a network controller, for example.

The illustrated logic of figures may show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to limit to the precise form disclosed. Many modifications and variations are possible in light of the above teaching.

What is claimed is:

1. An apparatus, comprising:
a non-volatile memory, said memory including:
a plurality of memory locations, each memory location configured to store data and having a physical address; and
repetitive address indirection control logic configured to receive a plurality of write operations for writing data to logical addresses of the memory, and further configured to repetitively redirect the writing of write data of the write operations to physical addresses in the memory in a circular sequence of physical addresses of the memory independently of logical addresses of the write operations, said repetitive address indirection control logic including:
circular sequential address redirection logic configured to, for every received write operation of the plurality of write operations, select a next-in-sequence physical address of the circular sequence of physical addresses of the memory, and perform the received write operation at the selected next-in-sequence physical address, wherein the circular sequence of physical addresses starts at a beginning physical address of the circular sequence, ends at an ending physical address of the circular sequence of physical addresses and includes physical addresses intermediate the beginning and ending physical addresses of the circular sequence; and
circular sequential address mapping logic configured to map a logical address of each received write operation to the selected next-in-sequence physical address; and
wherein the circular sequential address redirection logic is further configured to, if a selected next-in-sequence physical address is the ending physical address of the circular sequence of physical addresses, restart the circular sequence of physical addresses so that the next-in-sequence physical address to be selected is the beginning physical address of the circular sequence of physical addresses.

2. The apparatus of claim 1 wherein the circular sequential address redirection logic configured to select a next-in-sequence physical address of a circular sequence of physical addresses, has a head address pointer data structure configured to store a head address pointer, and is further configured to increment the head address pointer to point to the next-in-sequence physical address of the circular sequence of physical addresses, and to write the data of a received write operation to the next-in-sequence circular memory physical address pointed to by the head address pointer.

3. The apparatus of claim 2 wherein the circular sequential address redirection logic further has a tail address pointer data structure configured to store a tail address pointer, and wherein the circular sequential address redirection logic is further configured to, in connection with incrementing the head address pointer to point to the next-in-sequence circular memory physical address of the circular sequence of physical addresses, increment the tail address pointer to point to an offset next-in-sequence physical address of the circular sequence of physical addresses, wherein the offset next-in-sequence physical address pointed to by the tail address pointer is offset from the next-in-sequence physical address pointed to by the head address pointer by a predetermined number of physical addresses.

4. The apparatus of claim 3 wherein the circular sequential address redirection logic is further configured to, in connection with the incrementing a tail address pointer to point to an offset next-in-sequence physical address, to increment the tail address pointer to pointing to a current tail address pointer physical address, to point to an offset next-in-sequence physical address, and wherein the repetitive address indirection control logic is further configured to relocate valid data located at the offset next-in-sequence physical address to another memory location to preserve the valid data from being overwritten by the writing of write data to physical addresses in the memory in a circular sequence of physical addresses of the memory.

5. The apparatus of claim 3 wherein the circular sequential address redirection logic is further configured to increment the head address pointer to point to the next-in-sequence physical address of the circular sequence of physical addresses so that valid data located at a current tail address pointer physical address is written to the next-in-sequence circular memory physical address pointed to by the head address pointer, to relocate the valid data located at the current tail address pointer physical address to the next-in-sequence circular memory physical address pointed to by the head address pointer.

6. The apparatus of claim 5 further comprising a temporary spare memory section provided by the memory locations of the physical addresses of the circular sequence of physical addresses between the physical address pointed to by the head address pointer and the physical address pointed to by the tail address pointer, and wherein the next-in-sequence circular memory physical address pointed to by the head address pointer is at the head of the temporary spare memory section.

7. The apparatus of claim 1 wherein the repetitive address indirection control logic is further configured to receive a plurality of read operations for reading data from a logical address of the memory, and to selectively relocate the read data to a next-in-sequence physical address of the circular sequence of physical addresses of the memory; and
wherein the circular sequential address mapping logic is further configured to map the logical address of the read operations to the next-in-sequence physical address of the read data relocation.

8. The apparatus of claim 1 wherein each memory location includes a metadata field configured to store metadata, a user data payload field configured to store user data, and a single error correction code field configured to store an encoding of the entire memory location for error detection and correction.

9. A method, comprising:
receiving a plurality of write operations directed to logical addresses of a non-volatile memory; and
writing data of received write operations to physical addresses in the memory, said writing including repetitively redirecting the writing of write data of the plurality of write operations to physical addresses in the memory in a circular sequence of physical addresses of the memory, wherein for each received write operation of the plurality of write operations, the writing of data includes:
selecting a next-in-sequence physical address of the circular sequence;
performing a write operation at a selected physical address;
mapping the logical address to a selected physical address; and
if a selected physical address is an ending address of the circular sequence, restarting the circular sequence so that the next-in-sequence physical address to be selected is a beginning physical address of the circular sequence of physical addresses.

10. The method of claim 9 wherein the selecting a next-in-sequence physical address of a circular sequence of physical addresses includes incrementing a head address pointer to point to the next-in-sequence physical address of the circular sequence of physical addresses so that the write data of a received write operation is written to the next-in-sequence physical address pointed to by the head address pointer.

11. The method of claim 10 further comprising in connection with incrementing a head address pointer to point to the next-in-sequence circular memory physical address of the circular sequence of physical addresses, incrementing a tail address pointer to point to an offset next-in-sequence physical address of the circular sequence of physical addresses, wherein the offset next-in-sequence physical address pointed to by the tail address pointer is offset from the next-in-sequence physical address pointed to by the head address pointer by a predetermined number of physical addresses.

12. The method of claim 11 wherein the incrementing a tail address pointer to point to an offset next-in-sequence physical address includes incrementing a tail address pointer pointing to a current tail address pointer physical address, to point to an offset next-in-sequence physical address, and wherein the method further includes relocating valid data located at the offset next-in-sequence physical address to another memory location to preserve the valid data from being overwritten by the writing of write data to physical addresses in the memory in a circular sequence of physical addresses of the memory.

13. The method of claim 11 wherein relocating valid data located at a current tail address pointer physical address to another memory location includes incrementing the head address pointer to point to the next-in-sequence physical address of the circular sequence of physical addresses so that the data being relocated is written to the next-in-sequence circular memory physical address pointed to by the head address pointer.

14. The method of claim 13 wherein the physical addresses of the circular sequence of physical addresses between the physical address pointed to by the head address pointer and the physical address pointed to by the tail address pointer provide a temporary spare memory section of the memory, the method further comprising relocating valid data of the temporary spare memory section.

15. The method of claim 9 further comprising:
receiving a plurality of read operations for reading data from a logical address of the memory;
selectively relocating the read data to a next-in-sequence physical address of the circular sequence of physical addresses of the memory; and
mapping the logical address of the read operations to the next-in-sequence physical address of the read data relocation.

16. The method of claim 9 further comprising for each memory location, storing metadata in a metadata field, user data in a user data payload field, and an encoding of the entire memory location for error detection and correction, in a single error correction code field.

17. A computing system, comprising:
a memory; and
a processor configured to cause a data write into or data read from the memory;
wherein the memory is a non-volatile memory, said memory including:
a plurality of memory locations, each memory location configured to store data and having a physical address; and
repetitive address indirection control logic configured to receive a plurality of write operations for writing data to logical addresses of the memory, and further configured to repetitively redirect the writing of write data of the write operations to physical addresses in the memory in a circular sequence of physical addresses of the memory independently of logical addresses of the write operations, said repetitive address indirection control logic including:
circular sequential address redirection logic configured to, for every received write operation of the plurality of write operations, select a next-in-sequence physical address of the circular sequence of physical addresses of the memory, and perform the received write operation at the selected next-in-sequence physical address, wherein the circular sequence of physical addresses starts at a beginning physical address of the circular sequence, ends at an ending physical address of the circular sequence of physical addresses and includes physical addresses intermediate the beginning and ending physical addresses of the circular sequence; and
circular sequential address mapping logic configured to map a logical address of each received write operation to the selected next-in-sequence physical address; and
wherein the circular sequential address redirection logic is further configured to, if a selected next-in-sequence physical address is the ending physical address of the circular sequence of physical addresses, restart the circular sequence of physical addresses so that the next-in-sequence physical address to be selected is the beginning physical address of the circular sequence of physical addresses.

18. The system of claim 17 wherein the circular sequential address redirection logic configured to select a next-in-sequence physical address of a circular sequence of physical addresses, has a head address pointer data structure configured to store a head address pointer, and is further configured to increment the head address pointer to point to the next-in-sequence physical address of the circular sequence of physical addresses, and to write the data of a received write operation to the next-in-sequence circular memory physical address pointed to by the head address pointer.

19. The system of claim 18 wherein the circular sequential address redirection logic further has a tail address pointer data structure configured to store a tail address pointer, and wherein the circular sequential address redirection logic is further configured to, in connection with incrementing the head address pointer to point to the next-in-sequence circular memory physical address of the circular sequence of physical addresses, increment the tail address pointer to point to an offset next-in-sequence physical address of the circular sequence of physical addresses, wherein the offset next-in-sequence physical address pointed to by the tail address pointer is offset from the next-in-sequence physical address pointed to by the head address pointer by a predetermined number of physical addresses.

20. The system of claim 19 wherein the circular sequential address redirection logic is further configured to, in connection with the incrementing a tail address pointer to point to an offset next-in-sequence physical address, to increment the tail address pointer to pointing to a current tail address pointer physical address, to point to an offset next-in-sequence physical address, and wherein the repetitive address indirection control logic is further configured to relocate valid data located at the offset next-in-sequence physical address to another memory location to preserve the valid data from being overwritten by the writing of write data to physical addresses in the memory in a circular sequence of physical addresses of the memory.

21. The system of claim 19 wherein the circular sequential address redirection logic is further configured to increment the head address pointer to point to the next-in-sequence physical address of the circular sequence of physical addresses so that valid data located at a current tail address pointer physical address is written to the next-in-sequence circular memory physical address pointed to by the head address pointer, to relocate the valid data located at the current tail address pointer physical address to the next-in-sequence circular memory physical address pointed to by the head address pointer.

22. The system of claim 21 further comprising a temporary spare memory provided by the memory locations of the physical addresses of the circular sequence of physical addresses between the physical address pointed to by the head address pointer and the physical address pointed to by the tail address pointer, and wherein the next-in-sequence circular memory physical address pointed to by the head address pointer is at the head of the temporary spare memory section.

23. The system of claim 17 wherein the repetitive address indirection control logic is further configured to receive a plurality of read operations for reading data from a logical address of the memory, and to selectively relocate the read data to a next-in-sequence physical address of the circular sequence of physical addresses of the memory; and
wherein the circular sequential address mapping logic is further configured to map the logical address of the read operations to the next-in-sequence physical address of the read data relocation.

24. The system of claim 17 wherein each memory location includes a metadata field configured to store metadata, a user data payload field configured to store user data, and a single error correction code field configured to store an encoding of the entire memory location for error detection and correction.

25. The system of claim 17, further comprising any of:
a display communicatively coupled to the processor;
a network interface communicatively coupled to the processor; or
a battery coupled to provide power to the system.
